(19) United States
(12) Patent Application Publication
(10) Pub. No.: US 2007/0107794 A1
(43) Pub. Date: May 17, 2007

(54) Sprinkler tube

(76) Inventor: Gerhard ROSENBERG, (US)

Correspondence Address: DENNISON, SCHULTZ & MACDONALD, 1727 KING STREET, SUITE 105, ALEXANDRIA, VA, 22314, US

(21) Appl. No.: 11/278,830

(22) Filed: Apr. 6, 2006

(30) Foreign Application Priority Data
Sep. 14, 2005 (DE) 20 2005 014 586

(51) Int. Cl. F16L 9/14

(52) U.S. Cl. 138/141; 169/5; 252/8.05

(57) ABSTRACT

The invention refers to a multiple layer extruded sprinkler tube (10), formed by an internal, an intermediate and an external layer (12, 14 and 16) made of a polypropylene basis, in which at least the external layer (16) has a fire arresting additive and the intermediate layer (14) includes glass particles with a weight proportion of 10% to 50%.

The invention refers to a multilayered extruded sprinkler tube.

It is known that the DE-A-102 24 707 is a multilayered tube which has at least one external and one internal layer of extruded plastic. The description also indicates that it is possible to use any extrudable plastic compound, while the internal and external layers must be made of materials such as polyethylene or polypropylene in one side, and polyolefin or ethylene vinyl acetate on the other. The external layer has a non reactive foam coat and at least one additive, which particularly must be a halogen free fire protecting agent. Halogenated fire protecting agents with antimonoxide or phosphorus can also be applied. It is further foreseen that the external layer is reinforced with a compound of organic and inorganic fibers.

Also, when the corresponding non reactive foam coat must first react above the reaction temperature, it has been observed that during the tube manufacture some problems arise. If the corresponding tubes will be connected with fittings, threaded connections will be required as welding under high temperatures may lead to a foam agent reaction that can result in a tube deformation.

Multiple layer plastic tubes such as EP-A-0 470 605 or DE-C-100 18 324, which are made out of polyamide or polypropylene basis, can be used to carry aggressive agents such as fuel. There is the possibility that each layer contains the same basis material, for example random copolymerized polypropylene, whereby in an intermediate layer there are additionally present glass fibers, glass pellets and/or glass powder. The internal layer can also include a barrier material to minimize the additive migration from the internal layer to the external layer (EP-A-0 470 605).

The existing sprinkler tubes are metallic, so they have an adequate fire resistance degree. The connecting elements, such as sprinkler heads or tube ramification will be connected to the tubes with liquid-tight threaded connections. Additional sealing is likewise possible.

The present invention underlies the task of producing a multiple layer extruded sprinkler tube in such a way that fire prevention is provided in the required scope, in order to ensure the functionality of the sprinkler tube. At the same time, a problem-free tube manufacturing method must be achieved. The further connections with the sprinkler system components must be kept simple, while adequate pressure tightness is conserved.

The invention approaches the solution of this task with a multiple layer extruded sprinkler tube with in particular at least one welded connecting element for supporting a sprinkler head, socket or end cap including an internal, an intermediate and an external layer of propylene basis, whereby at least in the external layer includes a fire deterring additive and the intermediate layer contains glass fibers, glass pellets and/or glass powder with a weight proportion of 10% to 50%. In particular it is foreseen that in each of the layers the additive is incorporated in such a way that the weight proportion of the additives adds up to 4% to 12% on each layer, in particular 8% as the ideal value.

The polypropylene basis material must be in particular a randomly copolymerized polypropylene which has an ethylene content of 2 to 6% that shows a MFR (melt flow rate) value of 0.3 to 10 g/10 min under a testing temperature of 190° C. and a 5 kg load.

The connecting elements must be preferably made of the same material that the multiple layer tube, also of a polypropylene basis, in particular randomly copolymerized polypropylene basis.

A halogenated flame retardant agent may be used as an additive, whereby additional antimony trioxide can be added.

In particular, a halogen such as elemental bromine and antimony trioxide can be included as synergistic flame retarding compound, where the halogen content to antimony trioxide is about 1:2 to 1:4, 1:3 in average.

Other suitable flame protecting agents are likewise questioned. As also inorganic flame protecting agents can be used, like for example zinc borate or ammonium sulfate. Organic phosphorus flame protecting agents are also suitable, whereby typically aromatic and phosphoric acid alkyl esters are included, such as TCPP, tri-phenyl phosphate or trioctyl phosphate.

It must be observed that the used flame retarding agents fulfill the required mechanic design parameters such as fracture and pressure resistance values that a tube under pressure must withstand.

The thickness of the internal, intermediate and external layers must preferably be equal or at least similar. Is it alternatively foreseen that the internal, intermediate and external layers have the same or at least similar weight.

According to the invention, a sprinkler tube manufactured by co extrusion will be made available that will offer a trouble-free processing and whose individual layers are made of the same basis. The required fire protection for the specified scope will be attained by adding the necessary additive, so that the sprinkler tube is capable of fulfilling its function. Thereby if the connecting elements are made of the same basic material than the tube, a trouble-free welding is possible, so that in the required scope that the required tightness for the operational reliability is ensured. Welding the connection elements offers a material coherent splicing, where no additional adhesive elements will be required, ensuring that the specified tightness is ensured.

By using specific glass fibers in the intermediate layer, the advantage of an increased mechanical stability is achieved.

Thereby, if each of the layers is made of the same basis material, a simple manufacture is possible whereby the deformation based on different material properties will not arise as it currently happens in the actual industry state of the art.

In particular it is foreseen that the sprinkler tube is encased in form of a composite fiber tube with fire arresting additives as an option, preferably applied in the clearance between a cover. Further details, advantages and features of the invention arise not only from the claims, but they can also be inferred from the individual or combined characteristics from the subsequent drawings description as well as from the preferred application examples.

### IT IS SHOWN ON

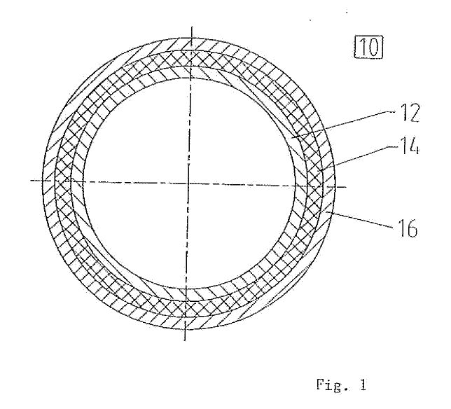

FIG. 1 A sectional view of a sprinkler tube and

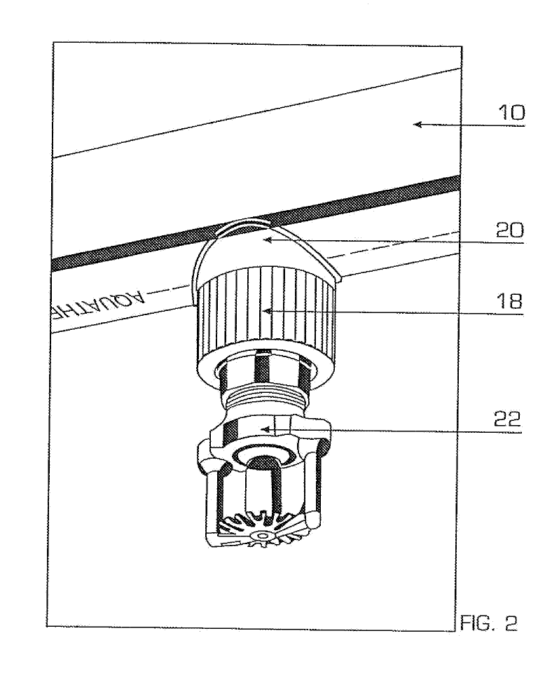

FIG. 2 A cut-out view of a sprinkler tube with a sprinkler head.

FIG. 1 shows a sectional view of the sprinkler tube 10 designed according to the invention, with the form of a composite fiber tube consisting of three layer, namely an internal layer 12, an intermediate layer 14 and an external layer 16. These layers 12, 14 and 16 may be extruded by means of co extrusion machinery.

In fact, there is the possibility that the sprinkler tube 10 may have more than three layers. However, the preferred construction method for the sprinkler tube 10 is that of three layers—12, 14 and 16.

Layers 12, 14 and 16 are made out of the same basic polypropylene material, whereby preferentially a randomly copolymerized polypropylene will be used, in fact in the form of PP-R (80) FS.

In particular it is foreseen that intermediate layer 14 is made of a randomly copolymerized polypropylene with a weight proportion of glass fibers and/or pellets and/or powder between 50% and 90%, preferably 60% to 80%, or a compound with a weight proportion of 10% to 50%, preferably 20% to 40%, as well as a bonding additive for splicing the randomly copolymerized propylene matrix with the glass fibers, pellets and/or powder. With the bonding additive it can be handled as a hydro silicone bonding.

The randomly copolymerized polypropylene must show an ethylene weight content of 2% to 6%, and a MFR (melt flow rate) value of 0.5 to 10 g/10 min at 190° C. under a load of 5 kg.

Additionally, at least the external layer 16 must include a fire arresting additive, which can be a halogenated compound like elemental bromine. Preferably, antimony trioxide must be added, and the halogen: antimontrioxyde content ratio must be between 1:2 and 1:4, preferably in average 1:3.

Other suitable flame arresting agents such as inorganic flame retarding compounds or organic phosphorus flame arresting agents, that may not contain chloride or bromide, are likewise possible. The weight proportion of the fire arresting compound additives preferably must be between 4% to 12%, in particular an average of 8%.

Accordingly, the internal layer 12 and the external layer 16 likewise may be made out of a randomly copolymerized polypropylene basis, whereby the internal and/or the external layers 12 and 16 must not have any stability increasing additions like glass fibers, pellets and/or powder. However, they must also include as well in the internal and external layers 12 and 16 the fire retarding additive respectively with a weight proportion between 4% to 12%. The ethylene content, as well as the MFR (melt flow rate) values of the internal and the intermediate layers 12 and 16 must correspond to those of the intermediate layer 14.

If glass fibers are used as additives for the intermediate layer, they must be short glass fiber with an output length between 0.1 mm and 6 mm. Alternatively, infinite fibers may be used that can be reduced by mixture or extrusion.

A homogeneous bonding material is obtained from the randomly copolymerized polypropylene and the mechanical resistance increasing additives like glass fibers, pellets or powder, whereby the glass fibers show a tex between 500 and 5,000. To increase the compound's characteristics, binding additives are added to the intermediate layer 14 incorporated forming output materials.

The cut-away view determines that the thickness of layers 12, 14 and 16 preferably must be the same. There is also the possibility that the layers have also the same weight.

A corresponding sprinkler tube 10 has a light construction while it shows at the same time the required mechanical resistance. Also in case or burning, the fire resistance is given within a scope that the sprinkler equipment may perform its function. In addition an in order to protect tube 10 against high temperatures, it must be placed inside a casing.

Preferably the tube must be placed in an area between two covers, or also between depending covers in the gap that separates them.

Thereby, if the sprinkler tube 10 is made of a basis material such as polypropylene plastic, it is possible to connect it in a simple way with the connecting elements such as sockets or end caps, as it is shown in principle in FIG. 2. A sectional view of the sprinkler tube 10 is shown in FIG. 2, that passer over a bore in an extension 18, to which the sprinkler tube 10 is welded. In an adequate scope there will be a welding material available, while the extension 18 shows a flange type rim 20 in the side of the tube, which will be welded with tube 10. For example, a sprinkler head 22 may then be screwed to the extension element 18. The extension element 18 may also include a fire arresting additive, in particular the same one used in sprinkler tube 10.

Thereby, if a material sealing connection is made between tube 10, extension 18 and the flange type section 20, the required thickness for tube 10 to have a running extinguishing agent cannot be avoided or controlled. This extinguishing agent can be supplied in either a liquid or a pulverized way.

1. Multiple layer extruded sprinkling tube (10), including an internal, an intermediate and an external layer (12, 14 and 16) made of a polypropylene basis, whereby at least in the external layer (16) must be added a fire arresting additive, as well as glass particles with a weight proportion of 10% to 50% in the intermediate layer.

2. Sprinkler tube according to claim 1, wherein the sprinkler tube (10) shows a welded extension element (18).

3. Sprinkler tube according to claim 1, wherein that the extension element (18) is made out of polypropylene basis plastic material.

4. Sprinkler tube according to claim 1, wherein that the glass particles used are either glass fibers, glass pellets or glass powder.

5. Sprinkler tube according to claim 1, wherein that the sprinkler tube (10) is made out of a randomly copolymerized polypropylene basis.

6. Sprinkler tube according to claim 2, wherein that the extension element (18) is made out of a randomly copolymerized polypropylene basis.

7. Sprinkler tube according to claim 1, wherein that the additive is a halogenated flame protecting agent.

8. Sprinkler tube according to claim 7, wherein that the fire arresting additive contains antimony trioxide.

9. Sprinkler tube according to claim 7, wherein that the fire arresting flame protection element contains halogen and antimony trioxide.

10. Sprinkler tube according to claim 9, wherein that the halogen used is elementary bromine.

11. Sprinkler tube according to claim 1, wherein that the fire arresting additive is a flame protecting agent from the inorganic flame protecting or organic phosphorus flame protecting agents.

12. Sprinkler tube according to claim 1, wherein that the fire arresting additive in added to each of the layers (12, 14 and 16) of the sprinkler tube (10).

13. Sprinkler tube according to claim 1, wherein that the fire arresting additive has a weight proportion between 4% and 12% based on the respective layers (12, 14 and 16).

14. Sprinkler tube according to claim 1, wherein that the fire arresting additive has a weight proportion of about 8% based on the corresponding layer (12, 14 and 16).

15. Sprinkler tube according to claim 9, wherein that the halogen to antimony trioxide content ratio is between 1:2 and 1:4.

16. Sprinkler tube according to claim 15, wherein that the halogen to antimony trioxide content ratio is in average 1:3.

17. Sprinkler tube according to claim 1, wherein that the thicknesses of the internal, intermediate and external layers (12, 14 and 16) are equal or at least similar.

18. Sprinkler tube according to claim 1, wherein that the respective weight of the internal, intermediate and external layers (12, 14 and 16) are equal or at least similar.
